(19) United States
(12) Patent Application Publication
(10) Pub. No.: US 2013/0242785 A1
(43) Pub. Date: Sep. 19, 2013

(54) METHOD AND APPARATUS FOR LOGGING AND REPORTING EVENTS THAT COULD CAUSE ACCESSIBILITY PROBLEMS IN A WIRELESS COMMUNICATION NETWORK

(71) Applicant: INNOVATIVE SONIC CORPORATION, Taipei City (TW)

(72) Inventor: Yu-Hsuan Guo, Taipei City (TW)

(73) Assignee: INNOVATIVE SONIC CORPORATION, Taipei City (TW)

(21) Appl. No.: 13/845,518

(22) Filed: Mar. 18, 2013

Related U.S. Application Data
(60) Provisional application No. 61/612,692, filed on Mar. 19, 2012.

(51) Int. Cl. H04W 24/00

(52) U.S. Cl. CPC H04W 24/00
USPC 370/252

(57) ABSTRACT

A method and apparatus are disclosed for logging and reporting events that could cause accessibility problems in a wireless communication system. The method includes logging, at m UE, in an event log an occurrence of an event where no cell could he found. The method also includes reporting the event log from the UE.

### CROSS-REFERENCE TO RELATED APPLICATIONS

The present Application claims the benefit of U.S. Provisional Patent Application Ser. No. 61/612,692 filed on Mar. 19, 2012, the entire disclosure of which is incorporated herein by reference.

### FIELD

This disclosure generally relates to wireless communication networks, and more particularly, to a method and apparatus logging and reporting events that could cause accessibility problems in a wireless communication network.

### BACKGROUND

With the rapid rise in demand for communication of large amounts of data to and from mobile communication devices, traditional mobile voice communication networks are evolving into networks that communicate with Internet Protocol (IF) data packets. Such IP data packet communication can provide users of mobile communication devices with voice over IP, multimedia, multicast and on-demand communication services.

An exemplary network structure fur which standardization is currently taking, place is an Evolved Universal Terrestrial Radio Access Network (E-UTRAN), The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed for logging and reporting events that could cause accessibility problems in a wireless communication system. The method includes logging, at an UE, in an event log an occurrence of an event where no cell could be found. The method also includes reporting the event log from the UE.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a flow chart according to one exemplary embodiment.

FIG. 6 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA) time division multiple access; (TDMA), orthogonal frequency division multiple access (OFDMA), 3GPP LTE (Long Term Evolution)wireless access, 3GPP LTE-A or LTE-Advanced (Long Term Evolution Advanced), 3GPP2 UMB (Ultra Mobile Broadband), WiMax, or some other modulation, techniques.

In particular, the exemplary wireless communication systems devices described below may be designed to support one or more standards such as the standard offered by a consortium named “3rd Generation Partnership Project” referred to herein as 3GPP, including Document Nos. RP-111361, “Enhancement of Minimization of Drive Tests for E-UTRAN and UTRAN”; R2-120507, “Accessibility measurements for MDT”, Ericsson: TS 36.331 V10.5.0, “RRC protocol specification (Release 10)”; TS 36.300 V11.1.0, “E-UTRA and E-UTRAN; Overall description; Stage 2”; R2-120927, “Stage 2 agreements on service continuity for MBMS For LTE”, Huawei; TS 36.304 V10.5.0, “UE procedures in idle mode”; TS 36.321 V10.4.0, “MAC protocol specification (Release 10)”; and TS 24.301 V11.1.0, “NAS protocol for EPS: Stage 3”. The standards and documents listed above are hereby expressly incorporated herein.

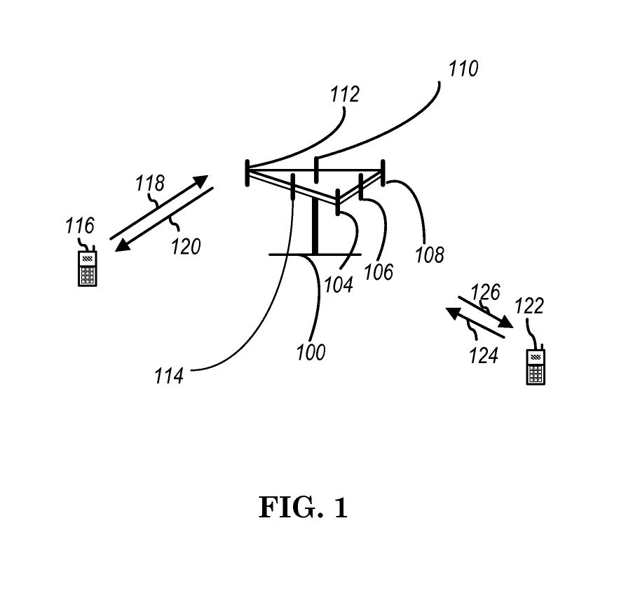

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT), is in communication with antennas 112 and 114, where antennas 1.12. and. 11.4 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication inks 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 114 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, ah enhanced base station, an eNodeB, or some, other terminology. An access terminal (AT) may also be called user equipment (UE), a wireless communication device, terminal, access terminal or same other terminology.

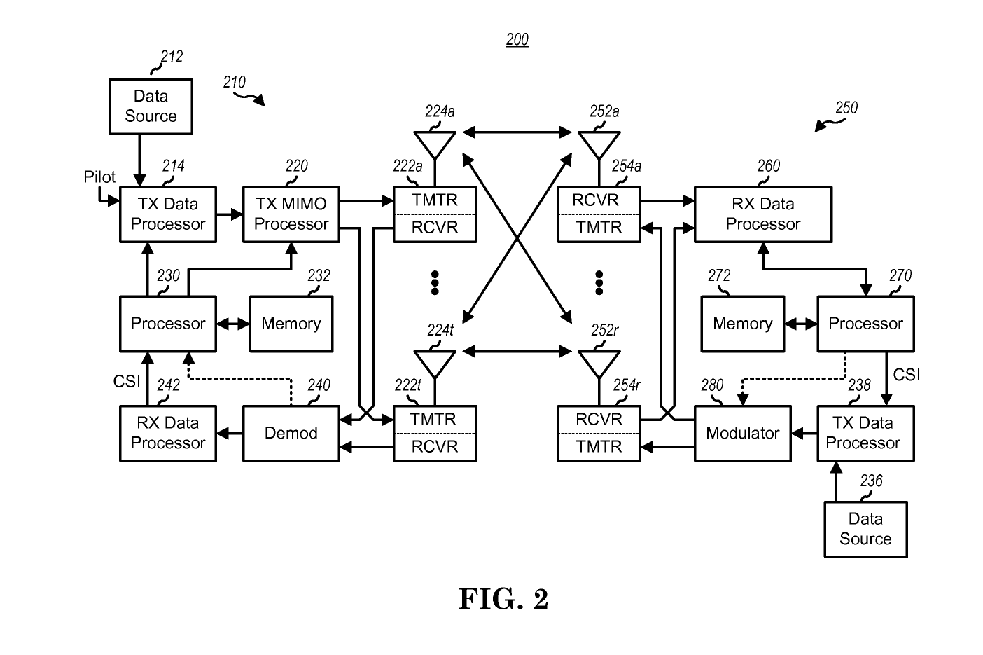

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit Antenna. TX data processor 214 formats, codes, and interleaves the traffic data for each data stream based on a particular coding scheme selected for that data stream to provide coded data.

The coded data for each data stream may fee multiplexed with pilot data using OFDM techniques. The pilot data is typically a known data pattern that is processed in a known manner and may be used the receiver system to estimate the channel response. The multiplexed pilot and coded data for each data stream is then modulated (i.e., symbol mapped) based on a particular modulation scheme (e.g., BPSK, QFSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by antennas 252a through 252r arid the received signal from each antenna 252 is provided to a respective receiver (RCVR) 254a through 254r. Each receiver 254 conditions (e.g., filters, amplifies and downconverts) a respective received signal, digitizes the conditioned signal to provide samples, and further processes the samples, to provide a corresponding “received” symbol stream.

An RX data processor 260 then receives and processes the N_{T} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

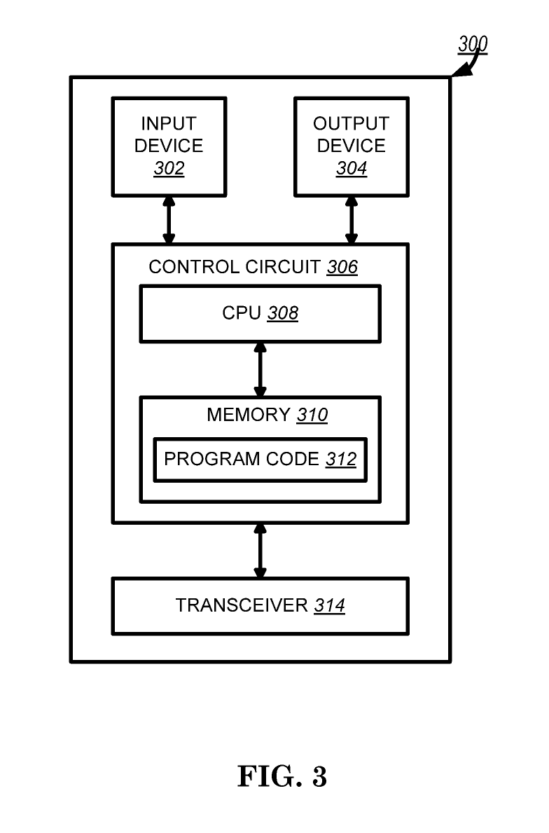

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output devise 304, such, as a monitor or speakers. The transceiver 314 is used to receive and transmit wireless signals, delivering received signals to the control circuit 306, and outputting signals generated by the control circuit 306 wirelessly.

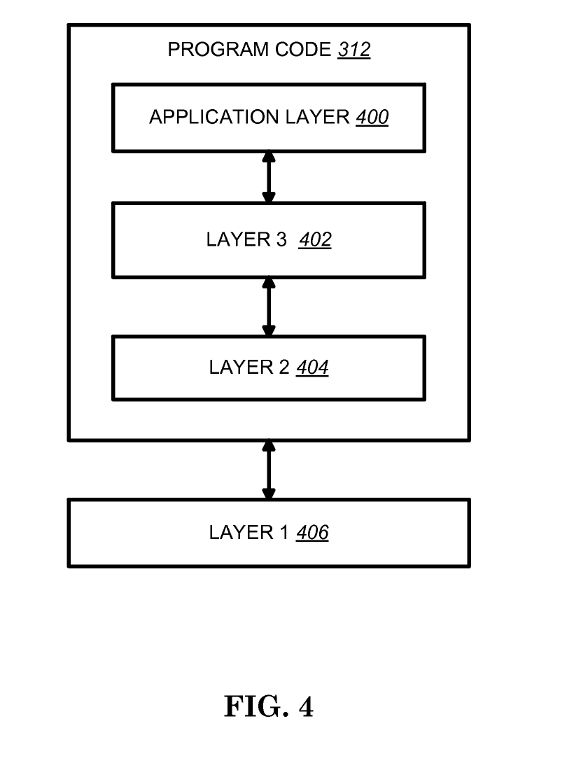

FIG. 4 is a simplified block diagram of the program code 312 shown in FIG. 3 in accordance with one embodiment of the invention. Un this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 general performs physical connections.

Some of the justification and objective of the work item “Enhancement of Minimization of Drive Tests for E-UTRAN and UTRAN” (3GPP RP-111361) include:

Using dove tests for network optimization purposes is costly and causes also additional CO₂ emissions, so it is desirable to have automated solutions, including involving UEs in the field, to reduce the operator costs for network deployment and operation.

The following use eases will be addressed:
Coverage Optimization
QoS (Quality of Service) Verification

3GPP RP-111361 provides the details pertaining to the work item. In particular, as pointed out in 3GPP RP-111361, the following aspect of the QoS use case should be considered:

It should be taken into account user-perceived non-availability of connection, e.g. at lack of coverage, frequent connection recovery or frequent handover. The actual coverage is assumed to be verified primarily with other (than QoS) measurements defined for coverage optimization use case.

As shown in 3GPP R2-120507, it was proposed in RAN2#7 meeting to discover problems during connection establishment based on the aforementioned aspect of the QoS use case. After some discussion, it is agreed that we will further consider the use ease of detecting and reporting failed RRC connection establishment attempts should be further considered as part of the Minimization of Drive Tests (MDT).

The details of MDT in Rel-10 (for example, Logged Measurement Configuration procedure or UE information procedure) can be found in 3GPP TS 36.331 V10.5.0. Furthermore, the details of MBMS. (Multimedia Broadcast Multicast Service) in Rel-10 can be found in 3GPP TS 36.331 V10.5.0 and TS 36.300 V11.1.0. In addition, the details of MBMS in Rel-11 can be found in 3GPP R2-120927. Also, the details of UE behavior RCC_IDLE (such as cell selection or cell reselection) can be found in 3GPP TS 36.304 V10.5.0.

Regarding accessibility problem, it may not be enough to only consider RRC connection establishment problem, such as timer T300 expiry (as specified in 3GPP TS 36.331 V10.5.0) or Random Access problem (as specified in 3GPP TS 36.321 V10.4.0). When no cell can be selected (for example, in a NO-CELL-AVAILABLE-state as discussed in 3GPP TS 24.301 V11.1.0):, RRC connection establishment would not be initiated by NAS layer (as discussed in 3GPP TS 24.301 V11.1.0). If RRC connection establishment is not initiated, the accessibility problem (arising from the fact that no cell could be selected) would not be logged or reported. In such situation, even though accessibility problems would exist, they could not be made known to the network through, report or informal currently provided by the UE (User Equipment). Examples of such report or information include: report for RRC connection establishment problem, MDT log report for RSRP and RSRQ carried by a UEInformationResponse message (as specified in 3GPP TS 36.331 V10.5.0), and RLF report and RACH report (as specified in 3GPP TS 36.331 V10.5.0). It would be beneficial to let operators be aware of the accessibility problems so that the operators could decide where to extend the coverage by the deployment of the new network nodes.

The general concept is to have the UE log situations where no cell could be found. For example, the situation may be that RRC connection is needed but RRC connection establishment cannot be initiated. The UE could then report the logs to network so that the operators could decide where and the scope of the coverage should be extended. For example, the operators could decide to extend coverage in a particular area based on the number of UEs having accessibility problem in the area. In other words, the decision to extend the radio coverage could be made precisely based on the logs, report or information provided by the UEs.

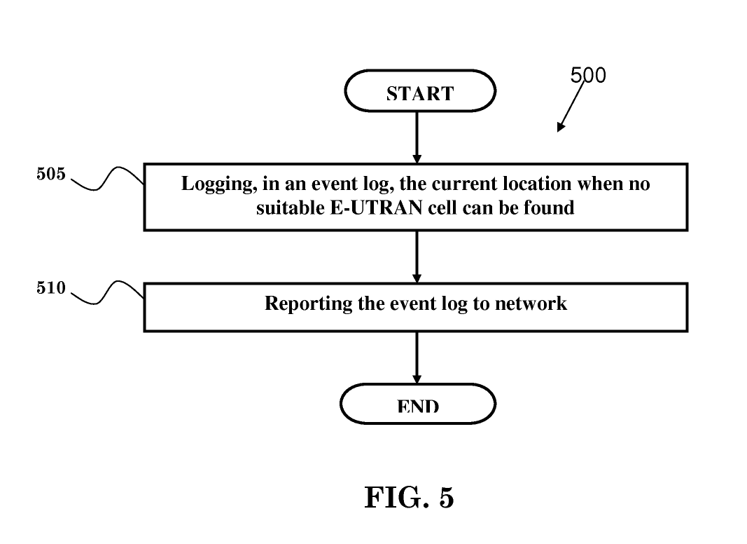

FIG. 5 is allow chart 500 according to one exemplary embodiment. In step 505. the UE logs its current location (which could include a longitude and a latitude) into an event log when no E-UTRAN (Evolved Universal Terrestrial Radio Access Network) cell could be found. In one embodiment, the UE is in RRC_IDLE mode. In addition, the UE needs to establish a RRC (Radio Resource Control) connection. The UE also has GPS (Global Positioning System) or GNSS (Global Navigation Satellite System) capability. In this embodiment, no cell could be found means (i)no suitable cell could be found (as specified in 3GPP TS 36.304 V10.5.0), or (ii) no acceptable cell could be found (as specified in 3GPP TS 36.304 V10.5.0), or (iii) the UE is in an “Any Cell Selection” state, a “Camped on Any Cell” state (as specified in 3GPP TS 36.304 V10.5.0), or a NO-CELL-AVAILABLE state (as specified in 3GPP TS 24.301 V11.1.0).

In one embodiment, the UE could be configured by the network to perform such logging activities. Furthermore, the UE could be configured to log once during a timer period that could be controlled by a prohibit timer or a periodic timer, or to log once for a location (or a specific area). The UE could also be configured to log only within a specific area or to log when no cell could be found for a continuous period of time. The UE could former be configured to log whether a cell of other RAT (Radio Access Technology), such as UTRAN (Universal Terrestrial Radio Access Network), could be found.

Returning to FIG. 5, in step 510, the UE reports the event log to the network. In one embodiment, the UE would report the event log when the UE receives a request to do so from the network. To report the event log, the UE could use a UEInformationResponse message or a MeasurementReport message (as specified in 3GPP TS 36.331 V10.5.0). The reported event log could then he used by the network to determine whether to expand radio coverage for an area.

Referring back to FIGS. 3 and 4 the device 300 includes a program code 312 stored in memory 310. In one embodiment, the CPU 308 could execute the program code 312 (i) to log, at a UE, in an event log an occurrence of an event where no cell could be found and (ii) to report the event log from the UE. In addition, the CPU 308 can execute the program code 312 to perform all of the above-described actions and steps or others described herein. In one embodiment, the reported event log could be used to determine whether to expand radio coverage for an area.

In addition, as discussed in 3GPP TS 36.331 V10.5.0, the MBMS Counting procedure is used by the E-UTRAN (Evolved Universal Terrestrial Radio Access Network) to count the number of RRC_CONNECTED mode UEs that are receiving specified MBMS services via a MRB (MBMS Point to Multipoint Radio Bearer) or are interested to receive specified MBMS services via a MRB. The network could then decide to start or stop the transmission of a MBMS service via a MRB based on the result of the counting.

However, the MBMS Counting procedure is not applicable to non MBMS capable cells, such as eels which do not connect to MCE or MBMS GW (as specified in 3GPP TS 36.300 V11.1.0). Also, the MBMS Counting procedure is not applicable to RRC_IDLE mode UEs. Thus, if the UEs are in the situations in which the MBMS Counting procedure does not apply, the unavailability of MBMS service reception via a MRB could not be made known to the network based on the reports, messages, and/or information currently provided by UEs. Examples of such reports, messages, and/or information include: the MBMSCountingResponse message (as specified in 3GPP TS 36.331 V10.5.0), the MBMSInterestIndication message (as specified in R2-120927), and the MDT log report for RSRP and RSRQ carried by a UEInformationResponse message (as specified in 3GPP TS 36.331 V10.5.0). It would be beneficial, especially for regular MBMS services, to let the operators know about the problem so that the operators can decide where to extend coverage, e.g., for a MBSFN area or a MBMS service area (as specified in 3GPP TS 36.300 V11.1.0), by deployment or upgrade of the network nodes.

The general concept is to have the UE Log occurrences where the UE is interested to receive a MBMS service that has already been started but the MBMS service could not be received through a MRB. The UE could then report the logs to the network. Based on the information provided in the logs, the operators could decide where and the scope of the coverage should be extended. For example, the operators could decide to extend coverage in a particular area based on the number of UEs having accessibility problem in the area. In other words, the decision to extend MBMS coverage could be made precisely based on the logs, report, or information provided by the UEs. Receiving a MBMS service through a MRB means that the MBMS service is received in MBSFN subframes.

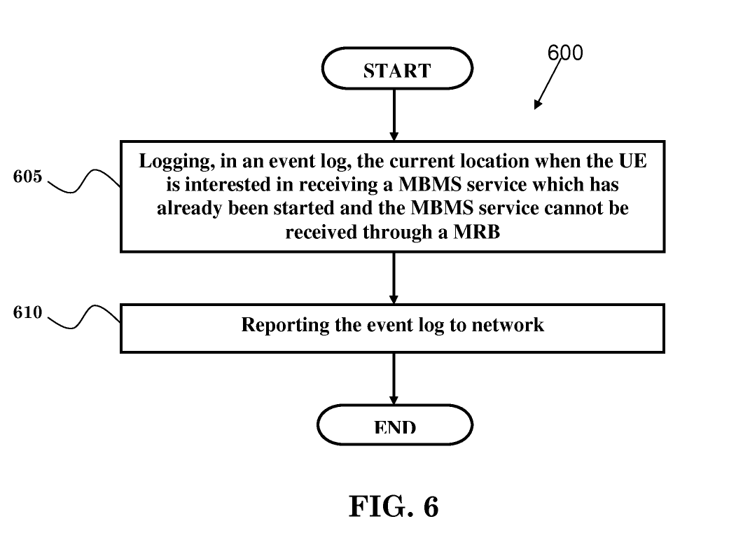

FIG. 6 is a flow chart 600 according to one exemplary embodiment. In step 605, the UE logs its current location (which could include a longitude and a latitude) into in an event log when the UE is interested in receiving a MBMS service that has already been started and the MBMS service cannot be received though a MRB. In one embodiment, the UE is in RRC_IDLE or RRC_CONNECTED mode. Furthermore, the UE could he in a MBSFN (MBMS Single Frequency Network) area associated with the MBMS service and could camp on (or connect to) a cell of the MBSFN area. The UE could also be in a MBMS service area associated with the MBMS service and could camp on (of connect to) a cell of the MBMS service area.

In one embodiment, the UE could be configured by the network to perform such logging activities. Furthermore, the UE could be configured to log once during a timer period that could be controlled by a prohibit timer or a periodic timer, or to log once for a location (or a specific area). The UE could also be configured to log only within a specific area or to log when the situation continues for a period of time.

In this embodiment, the UE could log the identification of the cell that the UE camps on or connects to when the situation occurs as its current location. Furthermore, the UE could log the identification of the MBMS service, and/or the time when the situation occurs.

In one embodiment, the MBMS service cannot be received through the MRB when (i) the SystemInformationBlockType13 cannot be received by the UE in a cell that the UE camps on or connects to, the SystemInformationBlockType13 received by the UE in the cell that the UE camps on or connects to does not contain information related to the MBMS service, (iii) the MBSFNAreaConfiguration message cannot be received by the UE in the cell that the UE camps on or connects to, (iv) the MBSFNAreaConfiguration message received by the UE in the cell that the UE camps on or connects to does not contain information related to the MBMS service, and/or (v) the MBSFN subframe(s) corresponding to the MBMS service cannot be received successfully by the UE.

Returning to FIG. 6, in step 610, the UE reports the event log to the network. In one embodiment, the UE would report the event log when the UE receives a request to do so from the network. To report the event log, the UE could use a UEInformationResponse message. The reported event log could then be used by the network to determine whether to expand radio coverage for an area.

Referring back to FIGS. 3 and 4, the device 300 includes a program code 312 stored in memory 310. In one embodiment, the CPU 308 could execute the program code 312 (i) to log, at a UE, in an event log an occurrence of a situation where the UE is interested in receiving a MBMS service that has already been started and the MBMS service cannot be received through a MRB (MBMS Point to Multipoint Radio Bearer), and (ii) to report the event log front the UE. In addition, the CPU 308 can execute the program code 312 to perform all of the above-described actions and steps or others described herein. In one embodiment, the reported event log could be used to determine whether to expand radio coverage for an area.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus maybe implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may he established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying, ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit if (“IC”), ail access terminal, or an access point. The IC may comprise a general purpose processor, a digital signal processor (DSP), an application specific integrated circuit (ASIC), a field programmable gate array (FPGA) of other programmable logic device, discrete, gate or transistor logic, discrete, hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order of hierarchy of steps in any disclosed process is an example, of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk. a removable disk, a CD-ROM, or any other form of computer-readable storage medium known in the art. A sample storage medium may be coupled to a machine such as, for example, a computer/processor (which may he referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some, aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for logging and reporting events that could cause accessibility problems in a wireless communication network, comprising:
logging, at an UE (User Equipment), in an event log an occurrence of an event where no cell could be found; and
reporting the event log from the UE.

2. The method of claim 1, wherein the UE is in a condition that needs to establish a RRC connection when no cell could be found.

3. The method of claim 1, wherein the event where no cell could be found occurs when no E-UTRAN (Evolved Universal Terrestrial Radio Access Network) cell could be found, no suitable cell could be found, no acceptable cell could be found, or the UE is in an “Any Cell Section” state, a “Camped on Any Cell” state, or a NO-CELL-AVAILABLE state.

4. The method of claim 1, wherein the UE logs a location (including a longitude and a latitude) associated with the event.

5. The method of claim 1, wherein the UE logs once during a predetermined period of time that could be controlled by a prohibit timer or a periodic timer, or once for a location or a specific area.

6. The method of claim 1, wherein the UE logs whether a UTRAN (Universal Terrestrial Radio Access Network) cell could be found.

7. The method of claim 1, wherein the UE reports the event log by using a UEInformationResponse message or a MeasurementReport message.

8. A communication device for logging and reporting events that could cause accessibility problems in a wireless communication network, the communication device comprising:
a control circuit;
a processor installed in the control circuit;
a memory installed in the control circuit and operatively coupled to the processor;
wherein the processor is configured to execute a program code stored in memory to log and report the events by;
logging, at an UE (User Equipment), in an event log an occurrence of an event where no cell could be found; and
reporting the event log from the UE.

9. The communication device of claim 8, wherein the UE is in a condition that needs to establish a RRC connection when no cell could be found.

10. The communication device of claim 8, wherein the event where no cell could be found occurs when no E-UTRAN (Evolved Universal Terrestrial Radio Access Network) cell could be found, no suitable cell could be found, no acceptable cell could be found, or the UE is in an “Any Cell Section” state, a “Camped on Any Cell” state, or a NO-CELL-AVAILABLE state.

11. The communication device of claim 8, wherein the UE logs a location (including a longitude and a latitude) associated with the event.

12. The communication device of claim 8, wherein the UE logs once during a predetermined period of time that could be controlled by a prohibit timer or a periodic timer, or once for a location or a specific area.

13. The communication device of claim 8, wherein the UE logs whether a UTRAN (Universal Terrestrial Radio Access Network) cell could be found.

14. The communication device of claim 8, wherein the UE reports the event log by using a UEInformationResponse message or a MeasurementReport message.

15. A method for logging and reporting events that could cause accessibility problems in a wireless communication network, comprising:
logging, at an UE (User Equipment), in an event log an occurrence of a situation where the UE is interested in receiving a MBMS (Multimedia Broadcast Multicast Service) service that has already been started and the MBMS service cannot be received through a MRB (MBMS Point to Multipoint Radio Bearer); and
reporting the event log from the UE.

16. The method of claim 15, wherein the UE is in a MBSFN (MBMS Single Frequency Network) area or a MBMS service area associated with the MBMS service.

17. The method of claim 15, wherein the UE logs (i) an identification of the cell that the UE camps on or connects to when the situation occurs, (ii) a location (including a longitude and a latitude) associated with the situation, (iii) an identification of the MBMS service, and/or (iv) a time when the situation occurs.

18. The method of claim 15, wherein the MBMS service cannot be received through the MRB could mean that (i) a SystemInformationBlockType13 cannot be received by the UE in a cell that the UE camps on or connects to, (ii) a SystemInformationBlockType13 is received by the UE in the cell that the UE camps on of connects to does not contain information related to the MBMS service, (iii) a MBSFNAreaConfiguration message cannot be received by the UE in the cell that the UE camps on or connects to, (iv) a MBSFNAreaConfiguration message received by the UE in the cell that the UE camps on or connects to does not contain information related to the MBMS service, and/or (v) MBSFN (MBMS Single Frequency Network) subframes(s) corresponding to the MBMS service cannot he received successfully by the UE.

19. The method of claim 15, wherein the UE logs the occurrence of the situation once during a predetermined period of time that could he controlled by a prohibit timer or a periodic timer, or once for location or a specific area.

20. The method of claim 15, wherein the UE reports the event log by using a UEInformationResponse message.
